(19) United States
(12) Patent Application Publication
(10) Pub. No.: US 2014/0134063 A1
(43) Pub. Date: May 15, 2014

(54) METHOD FOR COATING A CATALYSED PARTICULATE FILTER AND A PARTICULATE FILTER

(71) Applicants: Pär L. Gabrielsson, Helsingborg (SE); Keld Johansen, Frederikssund (DK)

(72) Inventors: Pär L. Gabrielsson, Helsingborg (SE); Keld Johansen, Frederikssund (DK)

(73) Assignee: Haldor Topsøe A/S, Kgs. Lyngby (DK)

(21) Appl. No.: 14/128,972

(22) PCT Filed: Jun. 14, 2012
(86) PCT No.: PCT/EP2012/061331

§ 371 Date: Dec. 23, 2013

(30) Foreign Application Priority Data
Jul. 13, 2011 (DK) PA 2011 00535

(51) Int. Cl. B01J 29/85; B01J 23/63

(52) U.S. Cl. CPC B01J 29/85; B01J 23/63
USPC 422/180; 502/100; 502/339; 502/60

(57) ABSTRACT

Method for the preparation of a wall flow particulate filter catalysed at its inlet side with a first catalyst having activity in the removal of residual hydrocarbons and carbon monoxide and catalysing at rich burn engine operation conditions the reaction of nitrogen oxides with hydrogen and/or carbon monoxide to ammonia and catalysed at its outlet side with a second catalyst having activity in the selective reduction of NOx by reaction with ammonia being formed in the inlet side. The method involves the provision of a first catalyst having a particle size larger than the filter wall mean pore size, and a second catalyst having a particle size smaller than the filter wall mean pore size, and mixing the first and second catalyst into one suspension, which is used for wash-coating from the inlet end. The second catalyst thereby diffuses into the partition wall.

The present invention relates to a multifunctional catalysed engine exhaust particulate filter. In particular, the invention is a method for the preparation of a multifunctional catalysed particulate filter being catalysed with a three way catalyst (TWC) and a catalyst being active in removing nitrogen oxides by the known NH3—selective catalytic reduction (SCR) process, and optionally with a catalyst having activity in the oxidation of excess ammonia to nitrogen.

The multifunctional catalysed filter is in particular useful for the cleaning of exhaust gas from lean burn gasoline engines, such as the gasoline direct injection (GDI) engine.

GDI engines generate more carbonaceous soot than gasoline premixed injection engines. In Europe the Euro 5+ Diesel legislation is expected to be used for GDI in the future with a particulate mass limit at 4.5 mg/km, which requires filtration of the engine exhaust in order to reach the above limit.

Typically, filters for use in automotive applications are the wall flow type filter consisting of honeycombed structured body, wherein particulate matter is captured on or in partition walls of the honeycomb structure. These filters have a plurality longitudinal flow channels separated by gas permeable partition walls. Gas inlet channels are open at their gas inlet side and blocked at the opposite outlet end and the gas outlet channels are open at the outlet end and blocked the inlet end, so that a gas stream entering the wall flow filter is forced through the partition walls before into the outlet channels.

In addition to soot particles, exhaust gas from gasoline engines contains nitrogen oxides (NOx), carbon monoxide and unburnt hydrocarbons, which are chemical compounds representing a health and environmental risk and must be reduced or removed from the exhaust gas.

Catalysts being active in the removal or reduction of NOx, carbon monoxide and hydrocarbons to harmless compounds are per se known in the art.

Patent literature discloses numerous cleaning systems comprising separate catalyst units for the removal of harmful compounds from engine exhaust gas.

Also known in the art are exhaust gas particulate filters coated with catalysts catalysing oxidation of hydrocarbons and particulate matter together with selective catalytic reduction (SCR) of NOx by reaction with ammonia being added as such or as precursor thereof into the exhaust gas.

Multifunctional diesel particulate filters coated with different catalysts catalysing the above mentioned reactions are also known in the art.

In the known multifunctional filters, the different catalysts are segmentarily or zone coated in different zones of the filter.

Segmentary or zone coating of different catalysts on the filter is an expensive and difficult preparation process.

Compared to known technique, the present invention suggests an easier method for the preparation of particulate filers catalysed with different catalysts for the selective reduction of nitrogen oxides with ammonia and removal of hydrocarbons, carbon monoxide and excess ammonia.

Thus, the invention provides a method of preparation of a catalysed wall flow filter, comprising the steps of

a) providing a wall flow filter body with a plurality longitudinal inlet flow channels and outlet flow channels separated by gas permeable porous partition walls;

b) providing a catalyst washcoat comprising a first catalyst composition being active in reaction of nitrogen oxides with carbon monoxide and hydrogen to ammonia and a second catalyst composition being active in selective reduction of nitrogen oxides by reaction with ammonia to nitrogen, the first catalyst composition having a mode particle size being larger than the average pore diameter of the porous partition walls and the second catalyst composition having a mode particle size smaller than the average pore diameter of the porous partition walls;

c) coating the filter body with the catalyst washcoat by introduction of the washcoat into inlet end of the inlet channels; and

d) drying and heat treating the coated filter body to obtain the catalysed particulate filter.

The advantage of the second catalyst has an mode particle size less than the mean pore diameter of the partition walls and the first catalyst particles have a larger mode particle size than the mean pore diameter of the walls is to allow the second catalyst particles to diffuse effectively into the partition walls and to prevent the first catalyst from diffusing into the channels where the specific catalytic activity is not desired.

It is then possible to coat the filter body with different catalysts inlet and outlet flow channels with a single washcoat.

Useful catalysts for the reaction of NOx to ammonia by the following reaction:

NOx+H₂/CO=NH₃+CO₂+H₂O

are palladium, platinum, a mixture of palladium and rhodium and a mixture of palladium, platinum and rhodium.

These catalysts catalyse the ammonia formation under rich burn operating conditions of the gasoline engine, i.e. λ<1. Palladium is the preferred catalyst with the highest ammonia formation.

Ammonia being thus formed within the inlet channels by the above reaction permeates through the partition walls of the filter into the outlet channels and is during the rich operating conditions adsorbed in the SCR catalyst in the outlet flow channels.

Both the ammonia forming catalyst and the SCR catalyst are preferably deposited on the partition walls on the sides facing the inlet channel and the outlet channel, respectively. Because of it particle size being less than the particle size of the pore diameters in partition walls, the SCR catalyst is also distributed within the pores of the walls.

In a subsequent lean burn operation cycle of the engine, NOx being present in the exhaust gas reacts with the ammonia stored in the SCR catalyst by the following reaction:

NOx+NH₃=N₂+H₂O

As already mentioned above, SCR catalysts are per se known in the art. For use in the invention, the preferred catalyst being active in the selective reduction of nitrogen oxides comprises at least one of a zeolite, a silica aluminum phosphate, an ion exchanged zeolite, silica aluminum phosphate promoted with iron and/or copper, one or more base metal oxides.

A further preferred SCR catalyst for use in the invention is a silica aluminium phosphate with chabazite structure, such as SAPO 34, promoted with copper and/or iron.

In order to remove the excess ammonia having not reacted with NOx, the wall flow filter comprises in an embodiment of the invention additionally an ammonia oxidation catalyst arranged in each outlet flow channel at least in the region of the outlet end of the filter.

A preferred ammonia oxidation catalyst comprises palladium, platinum or a mixture thereof.

By contact with the selective ammonia oxidation catalyst being coated on the SCR catalyst, ammonia is oxidised to nitrogen and water.

The ammonia oxidation catalyst may be deposited directly on the partition wall in the outlet channels of the filter in the outlet region or provided as surface layer on surface of the SCR catalyst layer.

The invention provides additionally a catalysed wall flow filter being prepared in accordance with the above disclosed inventive preparation method.

When preparing the washcoats for use in the invention, the catalysts being usually in particle form are milled or agglomerated to the required particle size and suspended in water or organic solvents, optionally with addition of binders, viscosity improvers, foaming agents or other processing aids.

The filter is then washcoated according to common practice, including applying vacuum in the filter, pressurizing the washcoat or by dip coating.

The amount of the first catalyst coated on the filter is typically 10 to 100 g/l, and the amount of the second catalyst on the filter is typically 10 to 140 g/l. The total catalyst loading on the filter is typically in the range of 40 to 200 g/l.

Examples of suitable filter materials for use in the invention are silicon carbide, aluminium titanate, cordierite, alumina, mullite or combinations thereof.

### EXAMPLE

A suspension of the first catalyst composition is in a first step prepared from a powder mixture of palladium and rhodium deposited on cerium oxide and alumina particles with a mode particle size larger than the filter wall mean pore size.

A suspension of the mixture first catalyst is prepared by mixing 20 g of these powders in 40 ml demineralised water pr liter filter. A dispersing agent Zephrym PD-7000 and an antifoam agent are added. The mode particle sizes of the final suspension must be larger than the mean pore diameter of the pores in the wall of the wall flow filter

A suspension of a second catalyst is made by mixing and dispersing 100 g of silica aluminium phosphate SAPO-34 promoted with 2% copper in 200 ml demineralised water pr liter filter. A dispersing agent Zephrym PD-7000 and an antifoam agent are added. The suspension is milled in a bead mill. The mode particle sizes must be smaller than the mean pore diameter of the pores in the wall of the wall flow filter.

The suspensions of the first catalyst and the second catalyst are then mixed to one suspension.

A high porosity (approximately 60% and wall mean pore size approx 18 μm) conventionally plugged SiC wall flow filter is used.

The mixed suspensions of first and the second catalyst is washcoated from the filters the inlet end of the filters dispersions side by standard washcoat methods side, dried and calcined at 750° C.

1. A method of preparation of a catalysed wall flow filter, comprising the steps of
a) providing a wall flow filter body with a plurality longitudinal inlet flow channels and outlet flow channels separated by gas permeable porous partition walls;
b) providing a catalyst washcoat comprising a first catalyst composition being active in reaction of nitrogen oxides with carbon monoxide and hydrogen to ammonia and a second catalyst composition being active in selective reduction of nitrogen oxides by reaction with ammonia to nitrogen, the first catalyst composition having a mode particle size being larger than the average pore diameter of the porous partition walls and the second catalyst composition having a mode particle size smaller than the average pore diameter of the porous partition walls;
c) coating the filter body with the catalyst washcoat by introduction of the washcoat into inlet end of the inlet channels; and
d) drying and heat treating the coated filter body to obtain the catalysed particulate filter.

2. The method of claim 1, wherein the catalyst being active in conversion of nitrogen oxides to ammonia includes palladium, platinum, a mixture of palladium and rhodium and a mixture of palladium, platinum and rhodium.

3. The method of claim 1, wherein the catalyst being active in conversion of nitrogen oxides to ammonia consists of palladium.

4. The method according to claim 1, wherein the catalyst being active in the selective reduction of nitrogen oxides comprises at least one of a zeolite, a silica aluminum phosphate, an ion exchanged zeolite, silica aluminum phosphate promoted with iron and/or copper, and one or more base metal oxides.

5. The method according to claim 1, further comprising the steps of
providing a second washcoat containing a catalyst composition being active in the selective oxidation of ammonia; and
coating a part of the outlet channels at region at the outlet end with the second washcoat.

6. A catalysed wall flow filter being prepared in accordance with claim 1.
